(19) United States
(12) Patent Application Publication
(10) Pub. No.: US 2012/0020384 A1
(43) Pub. Date: Jan. 26, 2012

(54) FUEL TEMPERATURE DETERMINING APPARATUS

(75) Inventor: Naoki MIKAMI, Chiryu-shi (JP)

(73) Assignee: DENSO CORPORATION, Kariya-city (JP)

(21) Appl. No.: 13/188,548

(22) Filed: Jul. 22, 2011

(30) Foreign Application Priority Data
Jul. 22, 2010 (JP) 2010-164922

(51) Int. Cl. G01K 13/00

(52) U.S. Cl. 374/144; 374/E13.001

(57) ABSTRACT

A fuel temperature determining apparatus for an internal combustion is provided which determines the temperature of fuel delivered to a fuel injector without use of a pressure sensor. The fuel temperature determining apparatus includes a pressure sensor that measures the pressure of fuel delivered to the fuel injector and works to analyze an output of the pressure sensor to determine a cycle of a pressure pulsation created in the fuel. The fuel temperature determining apparatus also calculates the temperature of the fuel delivered to the fuel injector based on the cycle of the pressure pulsation.

### CROSS REFERENCE TO RELATED DOCUMENT

The present application claims the benefit of priority of Japanese Patent Application No. 2010-164922 filed on Jul. 22, 2010, the disclosure of which is incorporated herein by reference.

### BACKGROUND OF THE INVENTION

1. Technical Field

The present invention relates generally to a fuel temperature determining apparatus designed to deter mine the temperature of fuel to be delivered to a fuel injector installed in, for example, an automotive internal combustion engine without use of a temperature sensor.

2. Background Art

The quantity of fuel to be sprayed from a fuel injector usually depends upon the temperature of the fuel fed to the fuel injector. Some of fuel injection systems are, therefore, engineered to correct the quantity of fuel to be sprayed based on the temperature of the fuel.

The temperature of the fuel is typically measured using a temperature sensor. The temperature of fuel may, however, be required to be determined without use of the temperature sensor due to a factor that locations where the temperature sensor is to be installed is restricted or the number of parts of the fuel injection system is required to be decreased.

Japanese Patent First Publication No. 2007-321694 discloses a fuel injection quantity control system for automotive common rail engines. The fuel injection quantity control system calculates a balance between quantity of heat inputted into and that outputted from the fuel injector (which will also be referred to as a thermal input/output balance below) based on parameters such as the temperature of fuel discharged from a fuel supply pump, the temperature of coolant, the pressure in a common rail, the speed of the internal combustion engine, and the quantity of fuel to be sprayed from the fuel injector to derive the temperature of the fuel injector.

The thermal input/output balance is usually susceptible to production tolerances of parts engaging in the transfer of heat to or from the fuel injector or an ambient environment such as wind or rain to which a running vehicle is exposed. This will result in an error in calculating the temperature of fuel based on the thermal input/output balance.

### SUMMARY

It is therefore an object to provide a fuel temperature determining apparatus designed to calculate the temperature of fuel to be delivered to a fuel injector without use of a temperature sensor.

According to one aspect of an embodiment, there is provided a fuel temperature determining apparatus which may be employed with a fuel injection system for automotive vehicles and is designed to calculate the temperature of fuel to be delivered to a fuel injector installed in an internal combustion engine without use of a temperature sensor. The fuel temperature determining apparatus comprises: (a) a pressure sensor that measures the pressure of fuel to be delivered to the fuel injector installed in the internal combustion engine and output a signal indicative thereof; (b) a cycle determining circuit that analyzes an output of the pressure sensor to determine a cycle of a pressure pulsation created in the fuel; and (c) a fuel temperature determining circuit that determines the temperature of the fuel to be delivered to the fuel injector based on the cycle of the pressure pulsation, as determined by the cycle determining circuit.

Usually, when the pressure of the fuel changes, such a pressure change will propagate in the form of a pressure pulsation through the fuel. The propagation velocity of the pressure pulsation is equal to the velocity of sound. The lower the temperature of the fuel, the higher the propagation velocity of pressure pulsation. The increase in propagation velocity of the pressure pulsation will result in shortening of a cycle of the pressure pulsation. Based on such a fact, the fuel temperature determining circuit determines the temperature of the fuel as a function of the cycle of the pressure pulsation, as determined by the cycle determining circuit.

The relation between the cycle of the pressure pulsation and the temperature of the fuel is insensitive to the individual variability in dimension or operation of parts of the fuel injection system or a change in ambient environment, thus ensuring a high degree of accuracy in calculating the temperature of the fuel.

In the preferred mode of the embodiment, the fuel temperature determining circuit stores therein a fuel temperature characteristic representing a correlation between a cycle of a pressure pulsation of fuel and a temperature of the fuel and looks up the temperature of the fuel to be delivered to the fuel injector in the fuel temperature characteristic which corresponds to the cycle of the pressure pulsation, as determined by the cycle determining circuit.

Usually, the output of the pressure sensor contains noises, as generated from itself or reflected waves of the pressure. Such noises are preferably removed using a band-pass filter. Accordingly, the fuel temperature determining apparatus may also include a filtering circuit which works to extract a signal component of the output of the pressure sensor which falls within a frequency band in which the pressure pulsation is expected to lie. The cycle deter mining circuit determines the cycle of the pressure pulsation based on the signal component extracted by the filtering circuit.

The cycle determining circuit may calculate an average value of cycles of the pressure pulsation appearing for a given period of time after development of the pressure pulsation as the cycle of the pressure pulsation for use in determining the temperature of the fuel. This results in an increase in accuracy in calculating the temperature of the fuel.

For example, the fuel temperature determining circuit determines the temperature of the fuel based on the cycle of the pressure pulsation which has arisen from spraying of the fuel from the fuel injector. When the fuel is sprayed from the fuel injector, it will develop the pressure pulsation of the fuel delivered to the fuel injector. The time the fuel has been sprayed may be found, for example, by monitoring an injection control signal outputted to the fuel injector. The cycle of the pressure pulsation may be calculated accurately by sampling the output of the pressure sensor when the amplitude of the pressure pulsation becomes great.

The fuel temperature determining circuit may alternatively be designed to determine the temperature of the fuel based on the cycle of the pressure pulsation which arises from feeding of the fuel from a fuel supply pump to the fuel injector.

The pressurized feeding of the fuel from the fuel supply pump usually results in the pressure pulsation of the fuel. The time of such pressurized feeding (i.e., occurrence of the pressure pulsation) is known by monitoring an angular position of a cam shaft driving the fuel supply pump. The cycle of the pressure pulsation may, thus, be calculated accurately by sampling the output of the pressure sensor when the amplitude of the pressure pulsation becomes great.

The fuel temperature determining apparatus may be used with a fuel injection system which sprays the fuel, as fed from a fuel supply pump and stored in a common rail, from the fuel injector and which has a pressure-reducing valve that is to be opened to drain the fuel from the common rail to reduce a pressure of the fuel in the common rail. The fuel temperature determining circuit may alternatively be designed to determine the temperature of the fuel based on the cycle of the pressure pulsation which has arisen from opening of the pressure-reducing valve.

When the pressure-reducing valve is opened to drain the fuel from the common rail, it will result in the pressure pulsation of the fuel to be delivered to the fuel injector. The time of such opening of the pressure-reducing valve (i.e., occurrence of the pressure pulsation) is known by monitoring output of an on-signal to the pressure-reducing valve. The cycle of the pressure pulsation may, thus, be calculated accurately by sampling the output of the pressure sensor when the amplitude of the pressure pulsation becomes great.

The cycle determining circuit, the fuel pressure determining circuit, and the filtering circuit are implemented by software programs to be executed in, for example, a microcomputer or discrete hardware mechanisms, respectively.

### BRIEF DESCRIPTION OF THE DRAWINGS

The present invention will be understood more fully from the detailed description given hereinbelow and from the accompanying drawings of the preferred embodiment of the invention, which, however, should not be taken to limit the invention to the specific embodiment but are for the purpose of explanation and understanding only.

In the drawings:

FIG. 1 is a block diagram which illustrates a fuel injection system according to an embodiment of the invention;

FIG. 2(a) is a view which demonstrates a change in pressure pulsation of fuel with time;

FIG. 2(b) is a view which demonstrates a pressure pulsation, as expressed by the spectrum analysis;

FIG. 3(a) is a graph which represents a fuel temperature characteristic expressing a correlation between the temperature of fuel and the cycle of a pressure pulsation;

FIG. 3(b) is a graph which represents a relation between a sampling interval at which an output of a pressure sensor is to be sampled and the speed of an internal combustion engine;

FIG. 3(c) is a graph which represents a relation between the length of a path through which fuel flows and a filtering frequency band within which a band-pass filter passes frequencies;

FIG. 4 is a flowchart of a program to be executed by the fuel injection system of FIG. 1 to calculate a filtering frequency band;

FIG. 5 is a flowchart of a program to be executed by the fuel injection system of FIG. 1 to determine a fuel temperature characteristic representing a correlation between the cycle of a pressure pulsation of fuel and the temperature of the fuel; and

FIG. 6 is a flowchart of a program to be executed by the fuel injection system of FIG. 1 to calculate the temperature of fuel to be delivered to a fuel injector.

### DESCRIPTION OF THE PREFERRED EMBODIMENTS

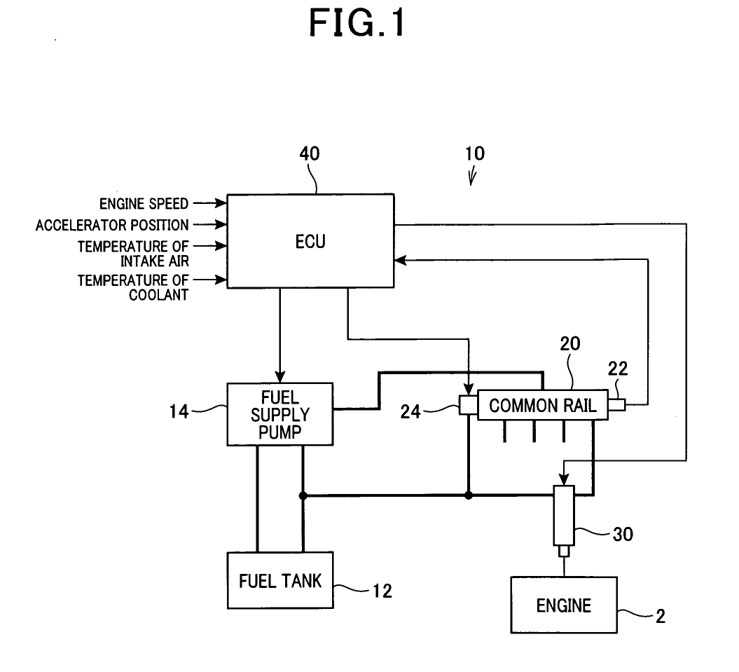

Referring to the drawings, wherein like reference numbers refer to like parts in several views, particularly to FIG. 1, there is shown a fuel injection system 10 according to an embodiment of the invention. The fuel injection system 10 is designed to inject fuel into, for example, a four-cylinder diesel engine 2 for automotive vehicles. The fuel injection system 10 is equipped with a fuel supply pump 14, a common rail 20, fuel injectors 30 (only one is shown for the sake of simplicity), and electronic control unit (ECU) 40.

The fuel supply pump 14 has built therein a feed pump to pump fuel from a fuel tank 12. The fuel supply pump 14 is of a typical type which has plungers reciprocating following rotation of a cam to pressurize and discharge the fuel sucked into pressure chambers.

The amount of fuel to be discharged from the fuel supply pump 14 is regulated by a suction control valve (not shown). The suction control valve is installed in an inlet of the fuel supply pump 14 and controlled in current supplied thereto to regulate the amount of fuel to be sucked into the pressure chambers during a suction stoke of the plungers, thereby adjusting the amount of fuel to be discharged from the fuel supply pump 14 to a set value.

The common rail 20 is a hollow cylinder working as an accumulator in which the fuel fed from the fuel supply pump 14 is to be stored. The common rail 20 has installed therein a pressure sensor 22 which measures an internal pressure of the common rail 20, that is, the pressure of fuel in the common rail 20 (which will also be referred to as a common rail pressure below).

The fuel injection system 10 also includes an engine speed sensor, an accelerator position (ACCP) sensor, a coolant temperature sensor, and an intake air temperature sensor which are used to monitor operating conditions of the engine 2. The engine speed sensor measure the speed NE of the engine 2. The accelerator position sensor measures the position of the accelerator pedal (i.e., a driver's effort on the accelerator pedal). The coolant temperature sensor measures the temperature of an engine coolant. The intake air temperature sensor measures the temperature of intake air to the engine 2.

The common rail 20 also has installed therein a pressure-reducing valve 24 that is a solenoid-operated valve which releases the pressure in the common rail 20 to a low-pressure side (i.e., the fuel tank 12). Specifically, the pressure-reducing valve 24 is opened by the ECU 40 to release the fuel from the common rail 20 to the fuel tank 12, thereby reducing the common rail pressure.

The fuel injector 30 is installed in each of the cylinders of the engine 2 and works to spray the fuel, as delivered from the common rail 2, into the cylinder. The fuel injector 30 is implemented by a typical injection valve designed to control the amount of lift of a needle through the pressure in a, control chamber to open or close a spray hole. The quantity of fuel to be sprayed from the fuel injector 30 (which will also be referred to as an injection quantity below) is controlled by a pulse width of an injection control signal outputted in the form of a pulse signal from the ECU 40. The injection quantity increases with an increase in pulse width of the injection control signal.

The ECU 40 is implemented by a typical microcomputer made up of a CPU, a RAM, a ROM, and a flash memory. The CPU executes control programs stored in the flash memory to control operations of the fuel injection system 10 using outputs from the sensors, as described above, including the pressure sensor 22.

For example, the ECU 40 serves to control the electric current to be supplied to the suction control valve of the fuel supply pump 14 to regulate the amount of fuel to be discharged therefrom to bring the common rail pressure, as measured by the pressure sensor 22, into agreement with a target value.

The ECU 40 also control the injection quantity (i.e., the quantity of fuel to be sprayed from the fuel injector 30), the injection timing of the fuel injector 30, and a pattern of multiple injections of fuel such as pilot injection and post injection performed before and after main injection.

The ECU 40 stores in the ROM or the flash memory an injection characteristic map which lists relations between the pulse width of the injection control signal to be inputted to the fuel injector 30 and the injection quantity in terms of preselected ranges of the common rail pressure. The ECU 40 calculates a target quantity of fuel to be sprayed from the fuel injector 30 as functions of the engine speed NE and the position of the accelerator pedal and then determines the pulse width of the injection control signal required to achieve the target quantity of fuel by looking up one of the relations of the injection characteristic map within the pressure range corresponding to the common rail pressure, as measured by the pressure sensor 22.

The quantity of fuel to be sprayed from the fuel injector 30 usually depends upon the temperature of the fuel delivered to the fuel injector 30. The ECU 40, therefore, works as a correcting circuit to correct the pulse width of the injection control signal based on the temperature of the fuel determined in the manner, as will be described later in detail, without use of a temperature sensor.

### Pressure Pulsation

The pressure pulsation occurring in fuel to be delivered to the fuel injector 30 will be described below.

Such pressure pulsation is usually induced by a sudden change in pressure of the fuel due to the spraying of fuel from the fuel injector 30, the pressure-feeding of fuel from the fuel supply pump 14, or the draining of fuel from the common rail 20 to the fuel tank 2.

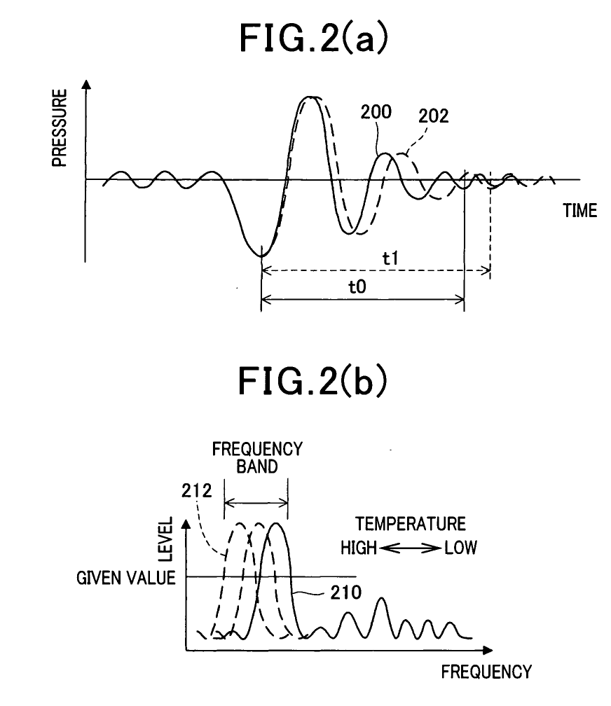

For instance, when the fuel injector 30 has sprayed the fuel, as demonstrated in FIG. 2(a), it will result in a sudden drop in pressure of the fuel delivered to the fuel injector 30, thus leading to the pressure pulsation 200. The pressure pulsation 200 decays with time.

The propagation velocity of the pressure pulsation is equal to the velocity of sound. The lower the temperature of the fuel, the higher the velocity of sound (i.e., the propagation velocity of pressure pulsation), while the higher the temperature of the fuel, the lower the velocity of sound. An increase in propagation velocity of the pressure pulsation will result in shortening of a cycle of the pressure pulsation (i.e., an increase in frequency of the pressure pulsation), while a decrease in propagation velocity of the pressure pulsation will result in lengthening of the cycle of the pressure pulsation (i.e. a decrease in frequency of the pressure pulsation).

Specifically, when the temperature of the fuel drops, the cycle of the pressure pulsation will be shortened, and the frequency of the pressure pulsation will be increased. Conversely, when the temperature of the fuel rises, the cycle of the pressure pulsation will be lengthened, and the frequency of the pressure pulsation will be decreased. The temperature of the fuel is expressed by a quadratic of the cycle of the pressure pulsation.

In FIG. 2(a), numeral 202 indicates the pressure pulsation arising from the spraying of fuel from the fuel injector 30 at the same time as the spraying of fuel giving rise to the pressure pulsation 200. The temperature of the fuel creating the pressure pulsation 202 is higher than that creating the pressure pulsation 200. If a period of time equivalent to three cycles of the pressure pulsation 200 is defined as t0, and that of the pressure pulsation 202 is defined as t1, a relation of t0<t1 will be met.

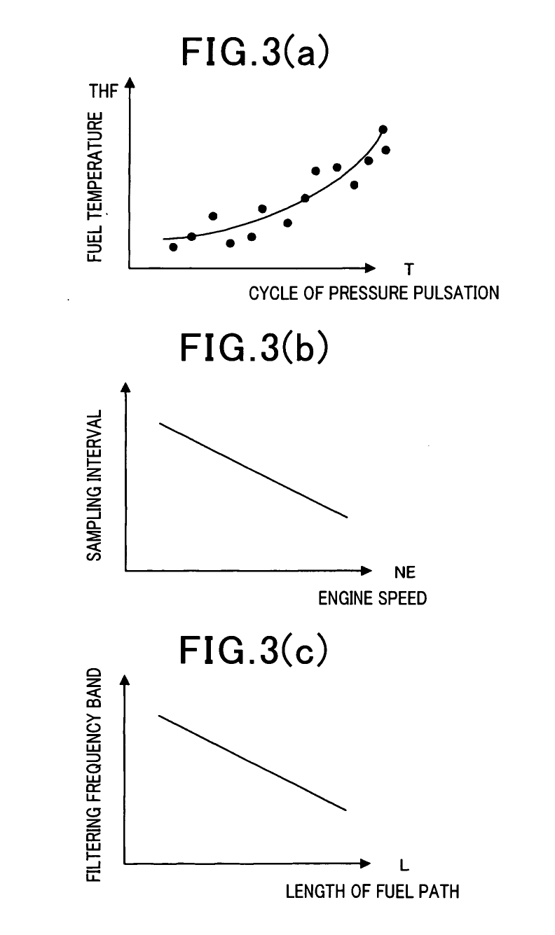

The temperature of the fuel delivered to the fuel injector 20 is, therefore, derived by finding a fuel temperature characteristic, as shown in FIG. 3(a), in advance which represents a correlation between the cycle of the pressure pulsation and the temperature of the fuel and calculating the cycle of the currently developing pressure pulsation using the waveform thereof, as demonstrated in FIG. 2(a).

### Calculation of Fuel Temperature

How to obtain the fuel temperature characteristic for use in calculating the temperature of the fuel as a function of the cycle of the pressure pulsation of the fuel will be described below.

First, the output of the pressure sensor 22 is sampled at each of temperatures preselected within a range over which the temperature of the fuel are expected to lie during running of the vehicle to count the cycle of the pressure pulsation of the fuel in terms of the temperature of the fuel. From the thus derived data on the correlation between the temperature of the fuel and the pressure pulsation of the fuel, coefficients α, β, γ of the following equation (1) that expresses the temperature of the fuel (TIM by a quadratic of the pressure pulsation (T) are evaluated in the least square method.

THF=αT²+βT+γ (1)

Usually, the output of the pressure sensor 22 contains noises, as generated from itself or reflected waves of the pressure. Such noises are preferably removed using a band-pass filter.

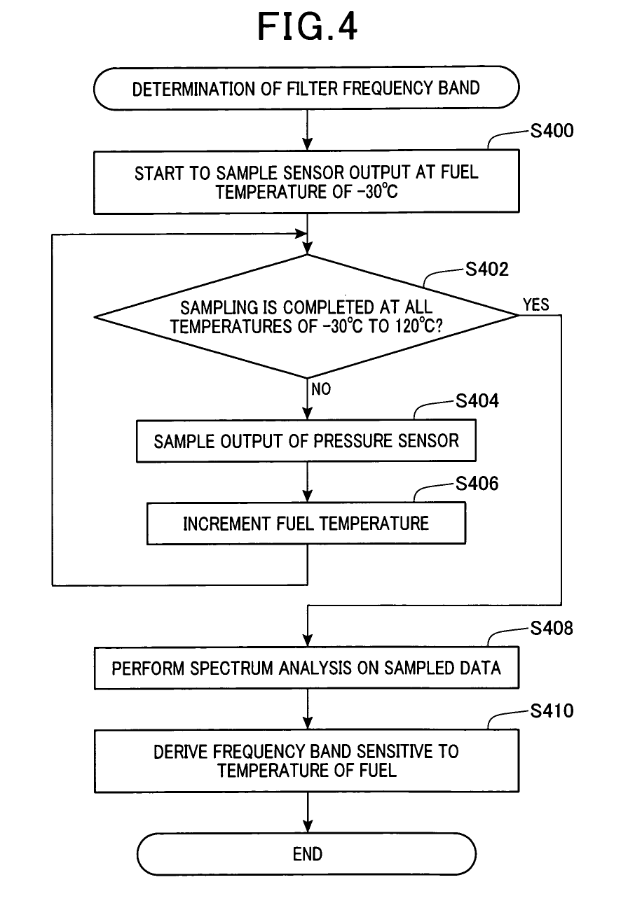

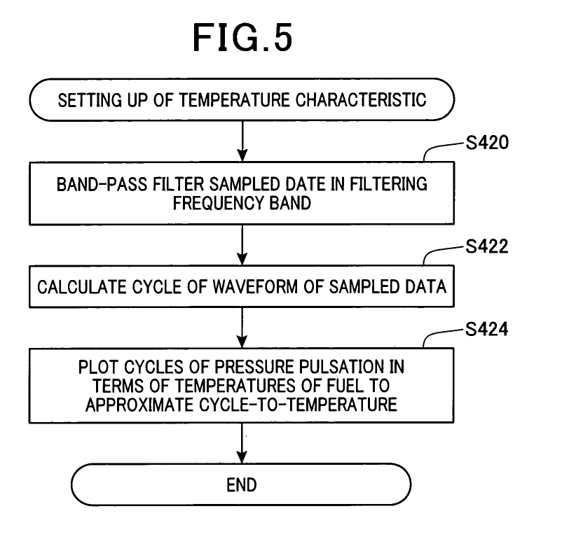

How to find a frequency band of the output from the pressure sensor 22 which is suitable for detecting the pressure pulsation of the fuel will be described with reference to FIG. 4. FIGS. 4 and 5 show sequences of logical steps or programs to be executed in, for example, an experimental laboratory using a fuel temperature regulator and a computer which performs complex operations such as the fast Fourier transform, etc. in addition to the fuel injection system 10.

### Determination of Filtering Frequency Band

The output of the pressure sensor 22 installed in the common rail 20 is sampled within each of preselected temperatures ranging from −30° C. to 120° C.

Specifically, in step S400 of FIG. 4, the temperature of the fuel in the common rail 20 is set to −30° C. The output of the pressure sensor 22 is to be sampled and converted into a digital form using an A/D converter. An interval or cycle of such sampling is determined, as illustrated in FIG. 3(b), as a function of the speed of the engine 2. The higher the speed of the engine 2, the shorter the sampling cycle.

In step S402, it is determined whether the sampling of the outputs of the pressure sensor 22 has been completed at all the temperatures of −30° C. to 120° C. or not. If a NO answer is obtained, then the routine proceeds to step S404 wherein the output of the pressure sensor 22 is sampled at the fuel temperature set in this program cycle. When this program cycle is the first cycle, the output of the pressure sensor 22 is sampled at a fuel temperature of −30° C. and stored in the RAM.

The output of the pressure sensor 22 is to be sampled cyclically to observe some cycles of the pressure pulsation of the fuel for a given period of time just after the ECU 40 instructs the fuel injector 30 to perform the main injection of fuel.

After the sampling of the outputs of the pressure sensor 22 has been completed at the fuel temperature set in this program cycle, the routine proceeds to step S 406 wherein the temperature of the fuel is elevated by a given increment. The routine then returns back to step S402.

When the sampling of the outputs of the pressure sensor 22 is completed at all the temperatures of −30° C. to 120° C., a YES answer is obtained in step S402. The routine then proceeds to step 408 wherein the spectrum analysis is performed on all the data, as sampled at all the temperatures of −30° C. to 120° C. through the fast Fourier transform to derive a relation, as demonstrated in FIG. 2(b), between the frequency and the level of the power spectrum in terms of each of the temperatures. Numeral 210 represents the level of the power spectrum when the temperature of the fuel is lower. Numeral 212 represents the level of the power spectrum when the temperature of the fuel is higher. The graph of FIG. 2(b) shows that the frequency of the peak of the power spectrum 210 is higher than that of the power spectrum 212.

Of frequencies of the power spectrums which are sensitive to the temperature of the fuel within a range of −30° C. to 120° C. and whose levels are greater than a given value, a band of lower ones is selected as a filtering frequency band.

The frequency of the pressure pulsation usually decreases with an increase in length of a fuel path in which the pressure pulsation propagates through the fuel. The filtering frequency band, thus, decreases, as demonstrated in FIG. 3(c), with an increase in length of the fuel path. Accordingly, the filtering frequency band is determined in terms of each of types of vehicles which are different in the length of the fuel path from each other.

### Setting Up of Fuel Temperature Characteristic

After the filtering frequency band is derived through the program of FIG. 4, the fuel temperature characteristic representing the correlation between the pressure pulsation of the fuel and the temperature of the fuel is obtained in the program of FIG. 5.

First, in step S420, the data, as sampled through steps S400 to S404 of FIG. 4, are band-pass filtered in the filtering frequency band, as derived in the program of FIG. 4. This filtering may be achieved by a software operation in the ECU 40.

The routine proceeds to step S422 wherein the cycle of the pressure pulsation of the fuel is calculated from the data, as derived through the band-pass filtering in step S420, which represents the waveform of the pressure pulsation of the fuel. Specifically, the cycle of the pressure pulsation is calculated based on the sampled number of cycles of the waveform and the length of time for the sampled number of cycles which are derived by monitoring or counting a sequence of peaks that are maximum values or minimum values of the waveform of the pressure pulsation or zero-levels of the waveform of the pressure pulsation.

The routine then proceeds to step S424 wherein the cycle of the pressure pulsation which has been obtained in the above manner is plotted, as illustrated in FIG. 3(a), in ter ins of each of the temperatures of the fuel set in the program of FIG. 4. The coefficients in the quadratic of the pressure pulsation, as expressed by Eq. (1), are evaluated in the least square method to derive the fuel temperature characteristic. The coefficients are stored in the ROM or the flash memory of the ECU 40.

### Calculation of Fuel Temperature

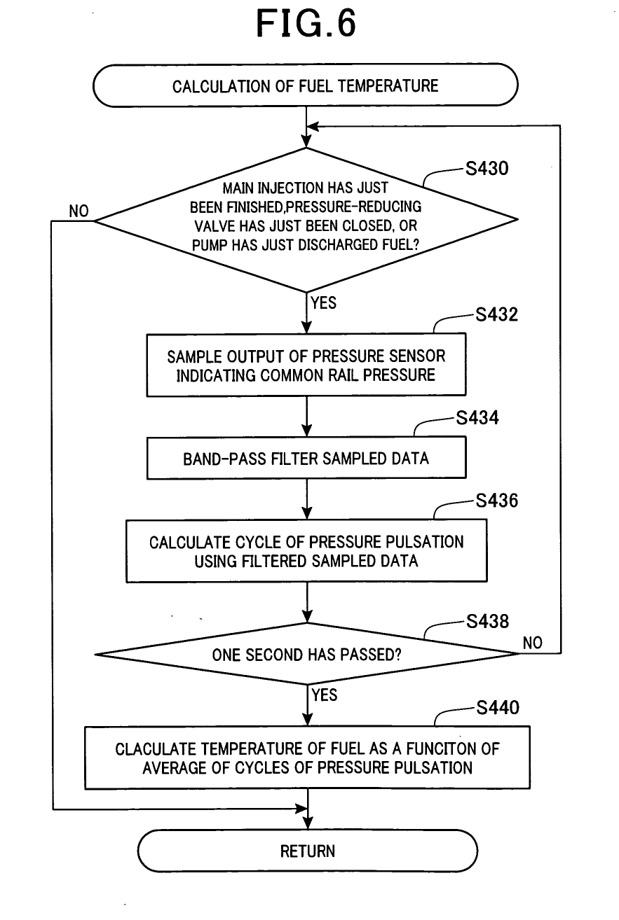

The ECU 40 stores a corresponding one of the fuel temperature characteristics, as derived through the programs of FIGS. 4 and 5, in terms of the types of the vehicles. The ECU 40 executes a program of FIG. 6 to determine the temperature of the fuel to be delivered to the fuel injector 30 by look-up using the fuel temperature characteristic during running of the vehicle (i.e., the engine 2). The program of FIG. 6 is run at all time when the ECU 40 is activated.

After entering the program, the routine proceeds to step S430 wherein it is determined whether at least one of three conditions: (1) where the main injection has just been finished, (2) where the pressure-reducing valve 24 has just been closed, and (3) where the fuel has just been fed from the fuel supply pump 14 to the common rail 20 is met or not. When one of the three conditions is met, the pressure pulsation of the fuel, as described above, will appear. If a YES answer is obtained in step S430 meaning that the time the temperature of the fuel is to be calculated has been reached, then the routine proceeds to step S432 wherein the ECU 40 samples the output of the pressure sensor 22 at the sampling interval, as determined as a function of the speed of the engine 2, and converts it into a digital form through the A/D converter, as described above. In the case where the fuel injection system 10 is engineered to perform the post-injection or after-injection of the fuel before or after the main injection of the fuel in the fuel injector 30, a YES answer is not obtained in step S430 even just after completion of the main injection.

The routine proceeds to step S434 wherein the ECU 40 low-pass filters the outputs of the pressure sensor 22, as sampled in step S432, within the filtering frequency band, as derived in the program of FIG. 4. The routine proceeds to step S436 wherein the ECU 40 analyzes the data, filtered in step S434, and calculates the cycle of the pressure pulsation of the fuel in the manner, as described above.

For instance, the ECU 40 continues to sample the output to from the pressure sensor 22 cyclically for a given period of time after the injection control signal is outputted to instruct the fuel injector 30 to execute a single event of the main injection of the fuel. The ECU 40 analyzes such sampled data and calculates an average value of a series of cycles of a waveform, as expressed by the sampled data, in the given period of time as one cycle of the pressure pulsation of the fuel to be delivered from the common rail 20 to the fuel injector 30. Specifically, as already described, the ECU 40 detects cyclic peaks (i.e., maximum or minimum values) or zero-levels of the waveform to extract a plurality of cycles of the waveform and then calculates the average value of the cycles as the cycle of the pressure pulsation of the fuel for use in calculating the temperature of the fuel.

After step S438, the routine proceeds to step S438 wherein it is determined whether one (1) second has passed or not after the ECU 40 starts to calculate the cycle of the pressure pulsation. If a NO answer is obtained meaning that one second has not yet passed, then the routine returns back to step S430. Alternatively, if a YES answer is obtained, then the routine proceeds to step S440 wherein the values of the cycles of the pressure pulsation of the fuel, as derived from a plurality of events of the main injection of the fuel executed within one second, are averaged. The ECU 40 then searches a value of the temperature of the fuel from the fuel temperature characteristic, as illustrated in FIG. 3(a), which corresponds to the averaged cycle of the pressure pulsation of the fuel and determines it as the temperature of the fuel which is now being delivered from the common rail 20 to the fuel injector 30.

The ECU 40 connects the pulse width of the injection control signal to be outputted to the fuel injector 30 based on the temperature of the fuel, as calculated in the above manner.

As apparent from the above discussion, the ECU 40 works to calculate the cycle of the pressure pulsation of the fuel delivered to the fuel injector using a sequence of outputs from the pressure sensor 22 installed in the common rail 20 and determine the temperature of the fuel through the fuel temperature characteristic representing the relation between the cycle of the pressure pulsation of the fuel and the temperature of the fuel without use of the pressure sensor.

The fuel temperature characteristic, as shown in FIG. 3(a), is insensitive to the individual variability in dimension or operation of parts of the fuel injection system 10 or a change in ambient environment, thus ensuring a high degree of accuracy in calculating the temperature of the fuel using the fuel temperature characteristic.

The ECU 40, as is clear from the above discussion, works as a fuel temperature determining circuit, a cycle determining circuit, and a filtering circuit. Specifically, the filtering circuit performs the operations of steps S432 and S434 in FIG. 6. The cycle determining circuit performs the operation of step S436. The fuel temperature determining circuit performs the operation of step S440.

The fuel injection system 10 may alternatively be used with direct gasoline-injection engines to calculate the temperature of fuel and correct the quantity of fuel to be sprayed into the engine based on the temperature of the fuel.

The fuel temperature determining circuit, the cycle determining circuit, and the filtering circuit are, as described above, implemented by the software in the ECU 40, however, at least one of them may be made by the hardware separate from the ECU 40. For example, the fuel injection system 10 may also be equipped with a band-pass filter which filters the sampled outputs of the pressure sensor 22.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A fuel temperature determining apparatus for an internal combustion engine comprising:
a pressure sensor that measures a pressure of fuel to be delivered to a fuel injector installed in an internal combustion engine and output a signal indicative thereof;
a cycle determining circuit that analyzes an output of the pressure sensor to determine a cycle of a pressure pulsation created in the fuel; and
a fuel temperature determining circuit that determines a temperature of the fuel to be delivered to the fuel injector based on the cycle of the pressure pulsation, as determined by the cycle determining circuit.

2. A fuel temperature determining apparatus as set forth in claim 1, wherein the fuel temperature determining circuit stores therein a fuel temperature characteristic representing a correlation between a cycle of a pressure pulsation of fuel and a temperature of the fuel and looks up the temperature of the fuel to be delivered to the fuel injector in the fuel temperature characteristic which corresponds to the cycle of the pressure pulsation, as determined by the cycle determining circuit.

3. A fuel temperature determining apparatus as set forth in claim 1, further comprising a filtering circuit that extracts a signal component of the output of the pressure sensor which falls within a frequency band in which the pressure pulsation is expected to lie, and wherein the cycle determining circuit determines the cycle of the pressure pulsation based on the signal component extracted by the filtering circuit.

4. A fuel temperature determining apparatus as set forth in claim 1, wherein the cycle determining circuit calculates an average value of cycles of the pressure pulsation appearing for a given period of time after development of the pressure pulsation as the cycle of the pressure pulsation for use in determining the temperature of the fuel.

5. A fuel temperature determining apparatus as set forth claim 1, wherein the fuel temperature determining circuit determines the temperature of the fuel based on the cycle of the pressure pulsation which has arisen from spraying of the fuel from the fuel injector.

6. A fuel temperature determining apparatus as set forth in claim 1, wherein the fuel temperature determining circuit determines the temperature of the fuel based on the cycle of the pressure pulsation which arises from feeding of the fuel from a fuel supply pump to the fuel injector.

7. A fuel temperature determining apparatus as set forth in claim 1, wherein the fuel temperature determining apparatus is used with a fuel injection system which sprays the fuel, as fed from a fuel supply pump and stored in a common rail, from the fuel injector and which has a pressure-reducing valve that is to be opened to drain the fuel from the common rail to reduce a pressure of the fuel in the common rail, and wherein the fuel temperature determining circuit determines the temperature of the fuel based on the cycle of the pressure pulsation which arises from opening of the pressure-reducing valve.
